(19) United States
(12) Patent Application Publication
(10) Pub. No.: US 2023/0104575 A1
(43) Pub. Date: Apr. 6, 2023

(54) HAND TOOL WITH CUTTING DEVICE

(71) Applicant: Burl Cole, Port St. Lucie, FL (US)

(72) Inventor: Burl Cole, Port St. Lucie, FL (US)

(21) Appl. No.: 17/909,699

(22) PCT Filed: Feb. 10, 2022
(86) PCT No.: PCT/US22/15883

§ 371 Date: Sep. 6, 2022

Related U.S. Application Data
(60) Provisional application No. 63/148,216, filed on Feb. 11, 2021.

(51) Int. Cl. B25F 1/04; B29C 63/02

(52) U.S. Cl. CPC B25F 1/04; B29C 63/02; B43M 7/002

(57) ABSTRACT

A hand tool having a squeegee and a retractable blade. The hand tool includes a main case having at least one flat edge. A squeegee is positioned on the flat edge of the main case and a retractable blade is extendable from the main case. The squeegee and retractable blade are incorporated in the single hand tool for use when desired by the user.

### RELATED APPLICATIONS

This utility application claims the benefit of U.S. Provisional Patent Application Ser. No. 63/148,216 filed Feb. 11, 2021, by Burl Cole, which is hereby incorporated by reference.

### BACKGROUND OF THE INVENTION

### Field of the Invention

This invention relates to hand tools. Specifically, and not by way of limitation, the present invention relates to a hand tool having a cutting device. In one embodiment, the hand tool includes a squeegee with a retractable blade.

### Description of the Related Art

Vinyl wrap are used to cover and protect various products, such as cars, boats, and airplanes. The vinyl wrap is a material having an adhesive side which is affixed to the product. Applying these wraps requires the use of various tools, most frequently a squeegee as well as a knife or some type of cutting tool. These are separate hand tools which require the user to trade off between using the two separate tools. It would be advantageous to have a hand tool which incorporates both a squeegee and a cutting device in one tool. It is an object of the present invention to provide such a hand tool.

### SUMMARY OF THE INVENTION

In one aspect, the present invention is directed to a hand tool. The hand tool includes a main case having at least one flat edge. A squeegee is positioned on the flat edge of the main case and a retractable blade is extendable from the main case. The squeegee and retractable blade are incorporated in the single hand tool for use when desired by the user.

### BRIEF DESCRIPTION OF THE DRAWINGS

FIG. 1 is a top view of a hand tool having a squeegee and an extendable blade;

FIG. 2 is a side view of the hand tool of FIG. 1;

FIG. 3 is a bottom view of the hand tool of FIG. 1 with the blade retracted;

FIG. 4 is another top view of the hand tool of FIG. 1 with the blade in a retracted position;

FIG. 5 illustrates a top view of the hand tool of FIG. 1 with the blade extended;

FIG. 6 is a top exploded view of a slot covering detached from the slot of the hand tool of FIG. 1;

FIG. 7 is a side view of the slider removed from the slot of the hand tool;

FIG. 8 is a top view of the main case illustrating the track and the slot;

FIG. 9 is a top view of the main case illustrating the slot with the slider and blade removed;

FIG. 10 is a top view of the hand tool having a letter opener blade in another embodiment of the present invention;

FIG. 11 illustrates a top view of the hand tool having the retractable blade and the letter opener blade positioned in a single slot;

FIG. 12A illustrates a hand tool having a rotatable letter opener blade;

FIG. 12B illustrates a hand tool having a rotatable letter opener blade with the retractable blade;

FIG. 13 is a top view of the hand tool with the extendable blade exiting from the corner and the retractable pen in another embodiment of the present invention;

FIG. 14 is a top view of the hand tool with the extendable blade, retractable pen, and the retractable needle tool;

FIG. 15A illustrates a bottom view of the hand tool with retracted tools;

FIG. 15B illustrates a top view of the hand tool of FIG. 15A with extendable blade, the retractable pen, and extendable needle in a cross configuration in another embodiment of the present invention;

FIG. 16 is a top view of the hand tool having the extendable blade and a safety cutter in another embodiment of the present invention;

FIG. 17 is a top view of the hand tool with the extendable blade and an extended squeegee;

FIG. 18 is a bottom view of the hand tool having a water injection system in another embodiment of the present invention; and

FIG. 19 is a front view of a blade having a front blade and a cutting edge in a snap off configuration.

### DESCRIPTION OF THE INVENTION

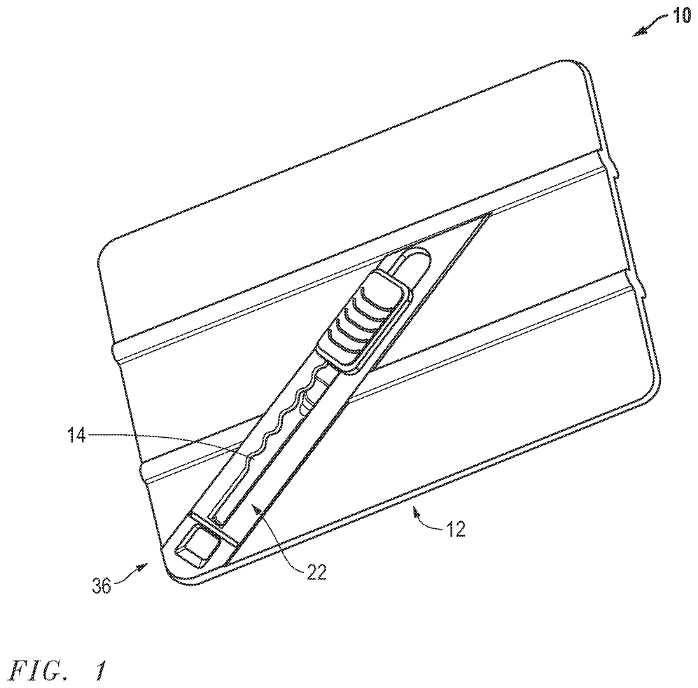

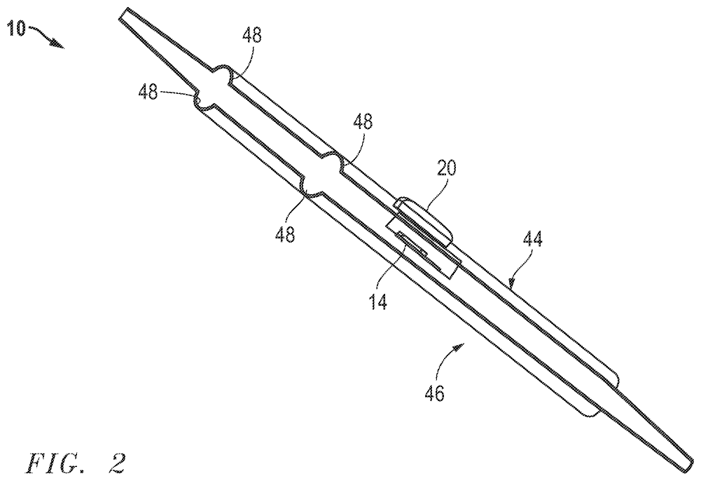

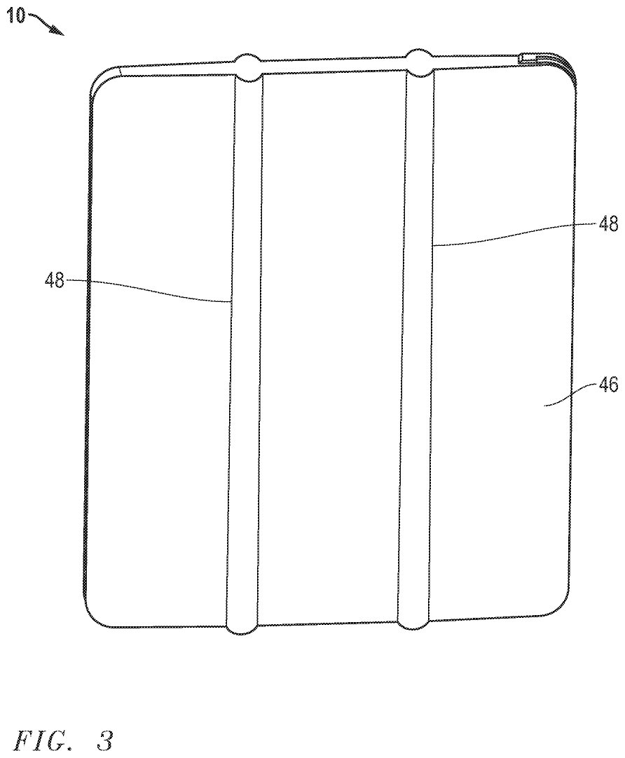

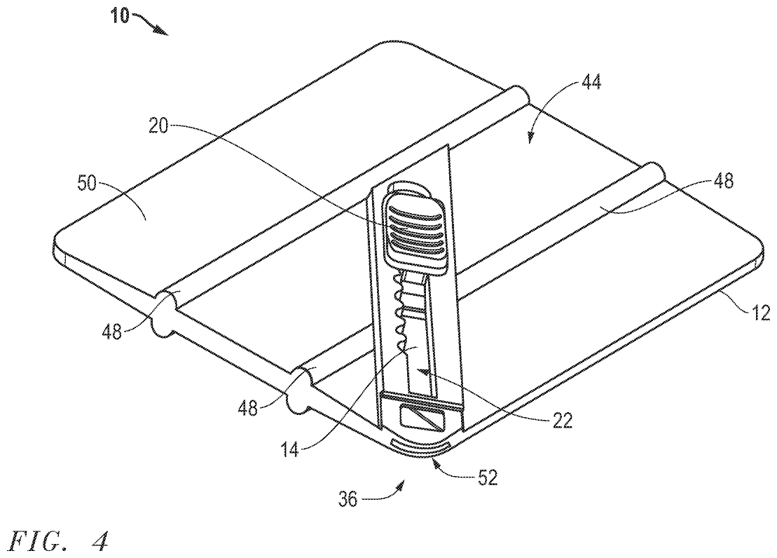

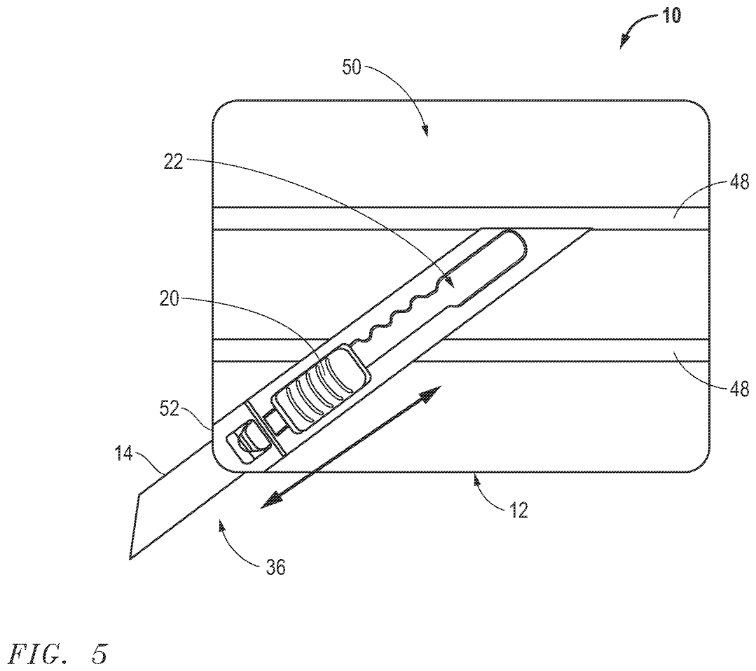

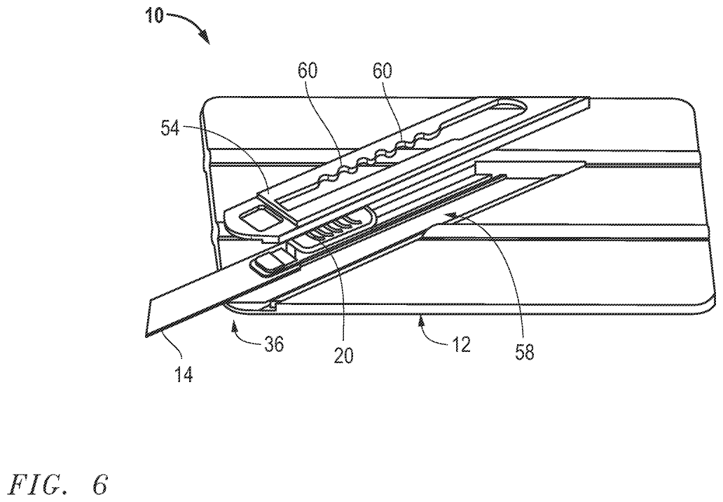

The present invention is a hand tool combining a squeegee with a cutting blade or cutting device. FIG. 1 is a top view of a hand tool 10 having a squeegee 12 and an extendable blade 14. FIG. 1 illustrates the hand tool 10 with the blade 14 retracted. The blade 14 is affixed to a slider (not shown in FIG. 1) having a button 20. The button 20 enables a user to move the blade in a slot 22 from the retracted position to the extended position by depressing the button. FIG. 2 is a first side view of the hand tool 10. In one embodiment, a top surface 44 and a bottom surface 46 includes ridges 48 extending from the top and bottom surfaces to provide a finger hold when utilizing the hand tool 10. FIG. 3 is a bottom view of the hand tool 10 with the blade retracted. FIG. 4 is another top view of the hand tool 10 with the blade 14 in a retracted position. In one embodiment, the blade 14 is positioned in a diagonal position with the blade exiting at a corner 36. As depicted, the blade runs diagonally within the slot 22 from a retracted position within an interior of a main case 50 and exits at an exit point 52 at the corner 36. However, in other embodiments, the blade 14 may be aligned in any direction which enables the blade to exit an edge, whether at a corner or not, between the top surface 44 and the bottom surface 46. As depicted in FIGS. 1-4, the blade 14 may be stored in a position that does not interfere with the squeegee when utilizing the squeegee. When the user wishes to use the blade, the blade can be extended. The squeegee 12 may be located on any edge of the main case and provides a flat surface for smoothing material (e.g., vinyl wrap) on an object. FIG. 5 illustrates a top view of the hand tool 10 with the blade 14 extended. FIG. 6 is a top exploded view of a slot covering 54 detached from the slot 22. The slot covering 54 normally covers the slot 22 and does not have to be removeable. The blade is attached to a slider 56. Additionally, the button 20 is affixed on a top surface of the slider 56. The slider 56 with the attached blade 14 slides within a track 58, allowing the retraction and extension of the blade within the slot 22. The slot 22 may include serrated edges 60, allowing the blade to be retained at various extensions from the exit point 52 by the serrated edges engaging or locking the slider in a stationary position. There are various embodiments or mechanisms which may be used to hold the blade in the extended position as well as the retracted position. For example, the blade may be spring-loaded to an extended or retracted position by a spring or other elastic cord which locks the blade in an extended or retracted position. Additionally, in another embodiment, the blade may rotate out from an edge of the main case in its extended position. Any retractable blade and extension device may be used and still remain in the scope of the present invention.

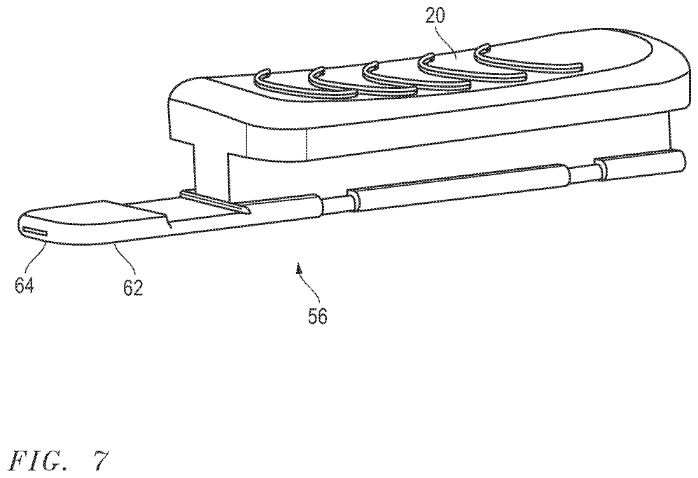

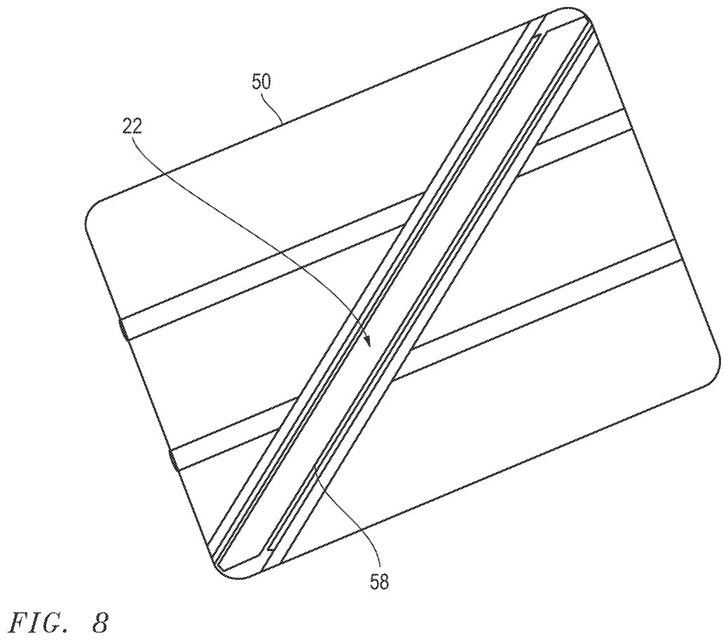

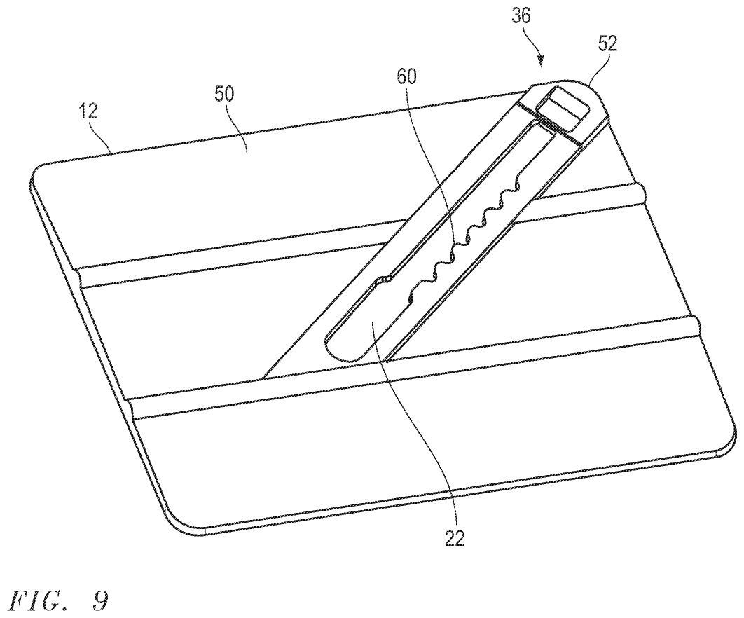

FIG. 7 is a side view of the slider 56 removed from the slot 22 of the hand tool 10. The slider includes a base 62 which is sized and shaped to fit on the track 58 within the slot 22. In one embodiment, the blade 14 may be affixed to an extension 64 of the base 62. However, the blade may be attached to any type of sliding mechanism which allows the blade to retract and extend from the main case 50 of the hand tool 10. FIG. 8 is a top view of the main case 50 illustrating track 58 and slot 22 with the slot covering 54, slider 56 and blade 14 removed for ease in viewing. FIG. 9 is a top view of the main case 50 illustrating the slot 22 with the slider 56 and blade 14 removed for ease in viewing.

With reference to FIGS. 1-9, the operation of the hand tool 10 will now be explained. As discussed above, the hand tool 10 has two features for use in many applications, such as vinyl wrapping of objects. One feature is a squeegee 12 which allows material to be smoothed over an object. The second feature is the retractable blade 14 which may be extended as necessary by the user from within the interior of the main case 50. In the retracted position as illustrated in FIGS. 1-4, the blade 14 affixed to the slider 56 is positioned within the interior of the main case 50 within the slot 22. In this retracted position, the blade is recessed within the interior without the blade protruding from the exit point 52. In the retracted position of the blade, the user may use the squeegee to smooth out material being affixed to an object (e.g., vinyl wrap on a car) without the blade interfering with the squeegee. If the blade is needed to perform cutting operations, the button 20 is depressed downward, which enables the slider 56 to slide upon the track 58 outward through the exit point 52, as shown in FIGS. 5 and 6. The button is then released, which locks or engages the slider in a fixed position. The serrated edges 60 allow the slot edges to engage the slider in a locked or fixed position anywhere on the track. When it is desired to retract the blade 14, the button 20 is depressed and the slider is disengaged or unlocked, allowing movement of the slider back into the interior of the case along the track 58.

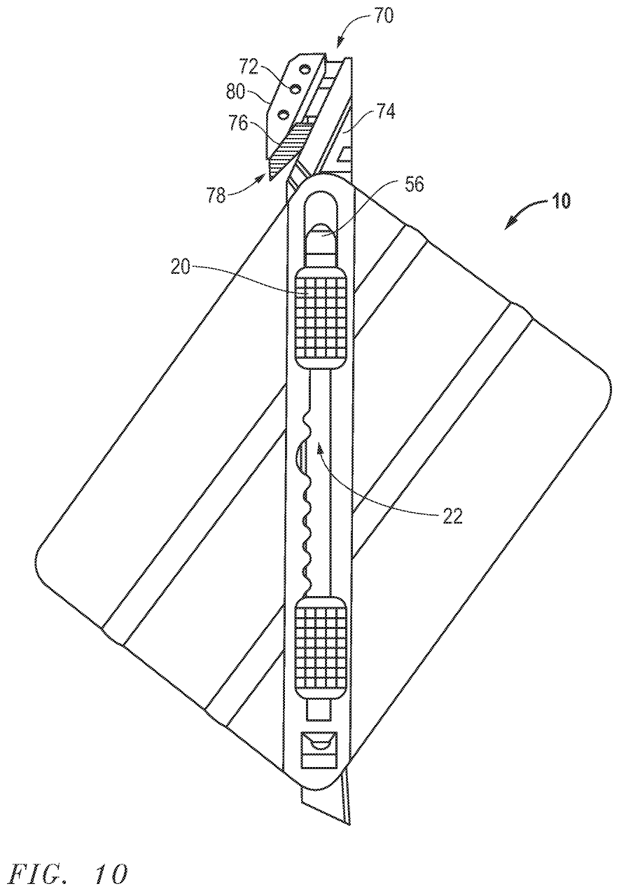

In another embodiment, the blade may be shaped in a similar fashion as a letter opener. FIG. 10 is a top view of the hand tool 10 having a letter opener blade 70 in another embodiment of the present invention. As depicted the letter opener blade includes a blade extension 72 which angles back towards a stem 74 of the blade 70. In this configuration, the blade 70 includes a cutting edge 76 which is positioned in a groove 78. On an opposition side of the blade is a smooth edge 80. In such a configuration, the blade 70 may cut material without cutting anything located below the material to be cut.

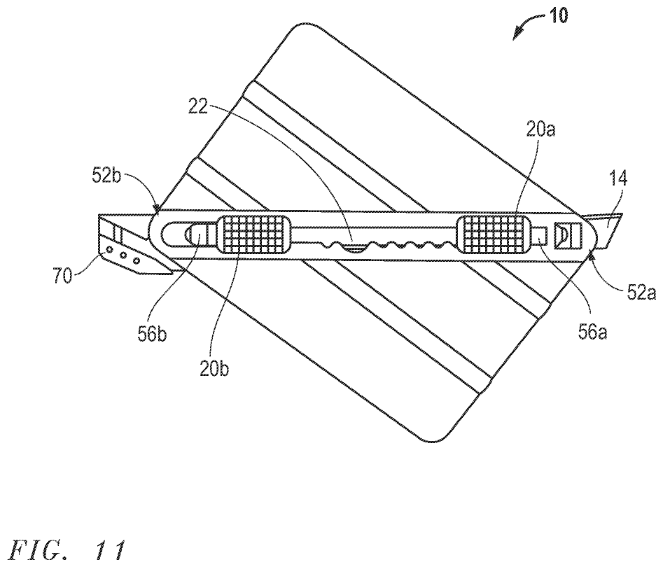

In another embodiment, the hand tool may have two blades. FIG. 11 illustrates a top view of the hand tool 10 having the blade 14 and the letter opener blade 70. In this embodiment, both blades utilize the same slot 22 and track 58 for enabling the sliders to slide within the slot. The blade 14 is affixed to the slider 56a which extends out through the exit point 52a. The blade 14 may be moved in the slot 22 by depressing the button 20a. On a diagonally opposite side, the blade 70 is affixed to the slider 56b which exits through the exit point 52b. The blade 70 may be moved in the slot 22 by depressing the button 20b. In another embodiment of the present invention, a single slider 56 may be utilized in the slot 22. The slider may be used to extend the blade 14 out of exit point 52a. Likewise, the same slider may be selected for use in extending out the blade 70 form exit point 52b. In this embodiment, a single slider is used to extend either the bade 14 or the blade 70.

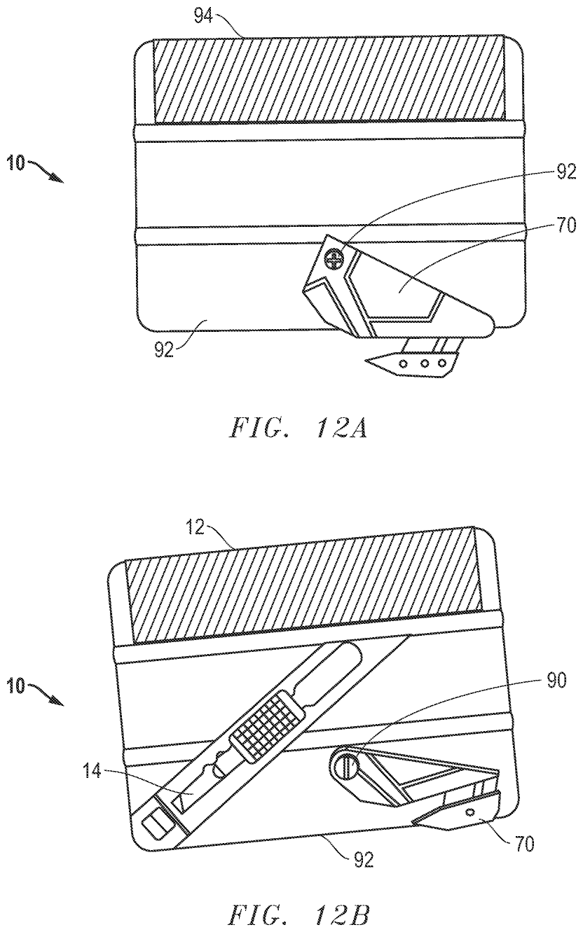

In another embodiment, the blade 14 or blade 70 may be rotatable out from an edge of the squeegee 12. FIG. 12A illustrates a hand tool 10 having a rotatable blade 70. FIG. 12B illustrates a hand tool 10 having a rotatable blade 70 with the blade 12 configured in a similar manner as depicted in FIGS. 1-6. With both the upper and lower hand tools 10 shown in FIGS. 12A and 128, the blades 70 are attached to the main case 50 at a pivot point 90. The upper hand tool 10 shows the blade 70 rotated to an extended position where the blade extends past an edge 92 of the main case 50. The lower hand tool 10 shows the blade 70 rotated to a retracted position where the blade is rotated to lie on the top surface 44 of the main case 50 without extending beyond the edge 92. In another embodiment, the squeegee 12 (shown in FIG. 128) may have a scraper 94 on an opposite surface from the squeegee 12 (shown in FIG. 12A). The scraper 94 may be a rigid blade of approximately four inches.

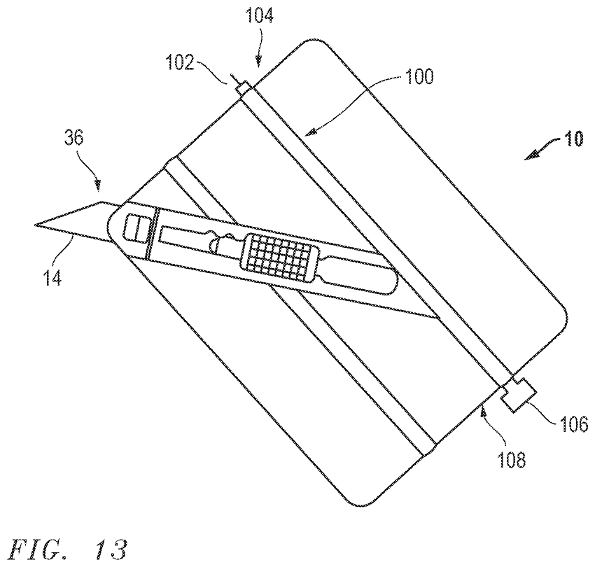

In another embodiment, the hand tool 10 may include a retractable pen or mechanism pencil 100. FIG. 13 is a top view of the hand tool 10 with the extendable blade 14 exiting from the corner 36 and the retractable pen 100 in another embodiment of the present invention. In another embodiment, the blade 14 may be positioned to extend anywhere along an edge of the main case. As depicted, the retractable pen is positioned within an interior of the main case 50 of the hand tool. The retractable pen may extend from an edge of the hand tool on a first end 102 on a first edge 104 of the main case 50 and include a second opposing end 106 on a second edge 108. The second end may be similar to a normal pen with depressing the end extending or retracting the pen. Although a pen is depicted, the present invention may utilize any writing utensil, such as a mechanical pencil, marker, etc.

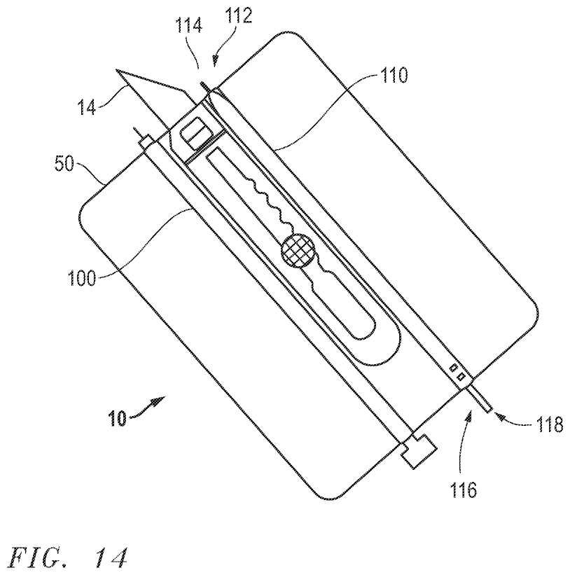

In another embodiment, the hand tool 10 may include a retractable pen 100 with a retractable needle tool 110. FIG. 14 is a top view of the hand tool 10 with the extendable blade 14, retractable pen 100 and the retractable needle tool 110. As depicted in FIG. 14, the extendable blade 14 extends from the edge 104. In another embodiment, the extendable blade may extend from the corner 36. The retractable needle tool 110 includes a first end 112 having a needle 114 and a second opposing end 116. The needle 114 may be extended or retracted by a button 118 located on the end 116. The needle may be positioned to extend out of any edge of the main case.

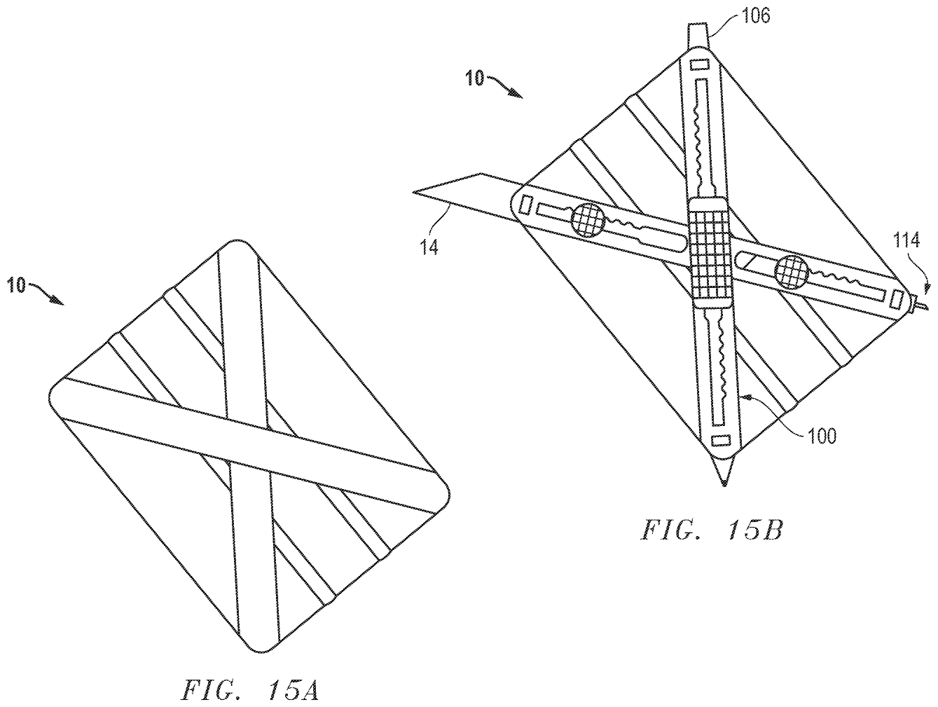

In another embodiment, the hand tool 10 may have several retractable tools. FIG. 15A illustrates a bottom view of the hand tool 10 with retracted tools. FIG. 15B illustrates a top view of the hand tool 10 with extendable blade 14, the retractable pen 100, and extendable needle 110 in a cross configuration in another embodiment of the present invention. The various tools may be configured any direction and utilize each corner or edge of the main case for exit points for extending the tools. In other embodiments, the various tools may be positioned to extend out of any position along an edge or corner of the main case.

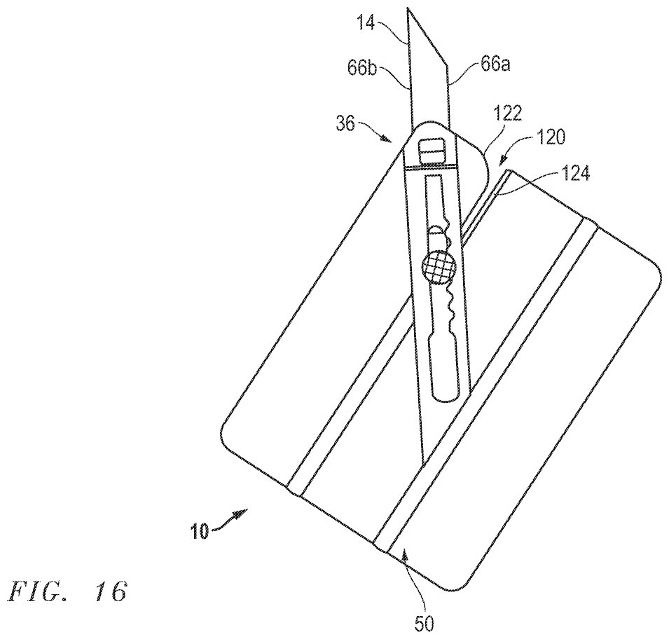

FIG. 16 is a top view of the hand tool 10 having the extendable blade 14 and a safety cutter 120 in another embodiment of the present invention. The extendable blade 14 is positioned on the corner 36, but in other embodiment, may be located along any edge of the main case 50. In one embodiment, the blade 14 may have dual cutting edges 66a and 66b. In another embodiment, the blade 14 may have a single cutting edge. In this embodiment, the safety cutter 120 may be utilized to provide a safe cutting surface. The safety cutter 120 includes a cutting blade 122 and a skid 124 to guide material toward the cutting blade 122. The safety cutter 120 may be located along any edge or corner of the main case 50. The safety cutter is ideal for cutting material, such as vinyl.

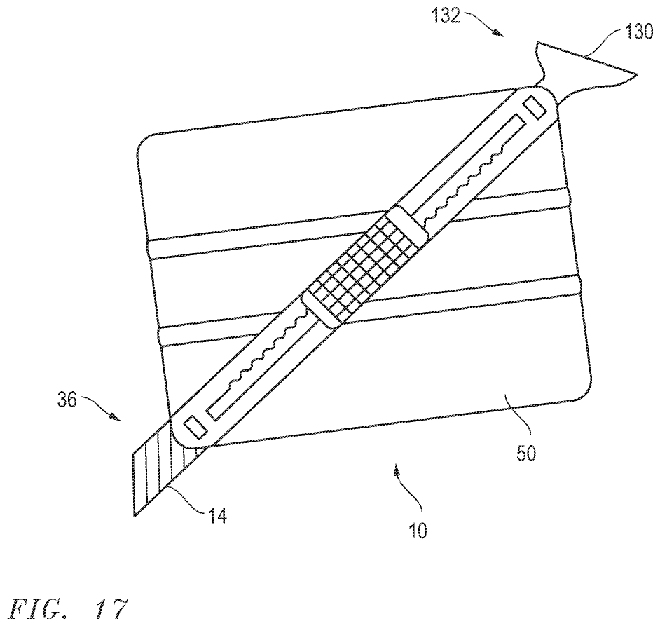

FIG. 17 is a top view of the hand tool 10 with the extendable blade 14 and an extended squeegee 130. As shown in FIG. 17, the hand tool may include an extended squeegee 130 located at a corner 132 of the main case 50. The extended squeegee 130 may be located on any edge or corner of the main case 50. The extended squeegee provides another tool for smoothing surfaces.

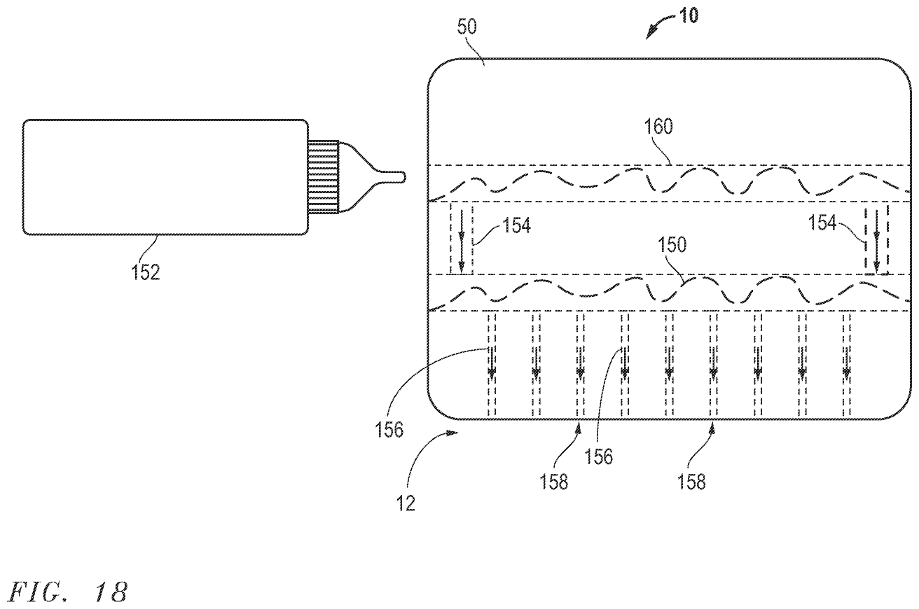

FIG. 18 is a bottom view of the hand tool 10 have a water injection system in another embodiment of the present invention. The hand tool 10 may include a water injection system which includes an entry reservoir 160 within the interior of the case 50. The reservoir 160 may be filled by an attachable water refill bottle 152. Water may be injected through passageways 154 from the bottom 150 of the reservoir 160, where water is stored when not in use by the hand tool 10. A plurality of channels 156 may be connected to the reservoir and lead to a plurality of water outlets 158 located along an edge of the squeegee 12. The reservoir may include a device to allow a user to apply pressure to the reservoir to force the water through the channels 156 and out the outlets 158 at the squeegee. In one embodiment, the reservoir may be constructed as a flexible bladder holding the water and where a user can press against a surface lying on an exterior of the case 50. A user may desire to apply water to a material for which the hand tool is being used, such as a vinyl material being applied to a surface. The water injection system may be configured in any manner that allows water to exit the case 50. Although not shown in FIG. 18, the hand tool 10 includes the extendable blade 14 (located on the opposite side of the case 50).

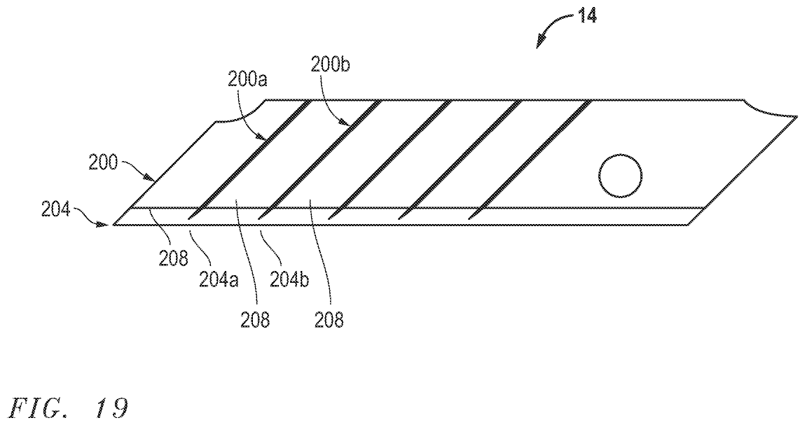

The present invention may utilize any cutting tool. Some examples include single cutting edged and dual cutting edged blades, as well as craft knifes having a diagonally aligned front blade and an edge blade. FIG. 19 is a front view of a blade 14 having a front blade 200 and a cutting edge 202 in a snap off configuration. The front blade may be orientated at an angle and provides a sharp point 204. In this embodiment, when the front blade 200 and/or sharp point 204 becomes dull, a first segment 208 may be “snapped off” of a main body 210 of the blade 14. By snapping off a segment 208, a new front blade 200a and sharp point 204a are revealed. As this segment dulls, it may be snapped off to reveal a new front blade 200b and sharp point 204a. The blade 14 may have a plurality of segments which may be removed to enable the blade 14 to remain sharp.

Although the blade may be retractable by utilizing a track, any configuration which enables the blade to be extended or retracted may be utilized. The present invention provides the advantages of two device, a squeegee, and a cutting tool in one apparatus. The cutting tool may be retracted or extended, as necessary. In other embodiments of the present invention, the present invention may be configured with one or more of the retractable or extendable tools discussed above. Additionally, preferably at least one of the blades is capable of cutting vinyl, canvas, paper, and plastic materials.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications, and embodiments within the scope thereof.

It is therefore intended by the appended claims to cover any and all such applications, modifications, and embodiments within the scope of the present invention.

1. A hand tool, the hand tool comprising:
a main case having at least one flat edge;
a squeegee positioned on the flat edge of the main case; and
a retractable blade extendable from the main case;
wherein the squeegee and retractable blade are incorporated in a single hand tool.

2. The hand tool according to claim 1, wherein the retracted blade resides in an interior of the main case when the blade is retracted.

3. The hand tool according to claim 2 wherein the retractable blade slides within a slot located on the main case.

4. The hand tool according to claim 3 wherein the retractable blade is oriented diagonally, and the blade extends from a corner of the main case when in an extended position.

5. The hand tool according to claim 3 further comprising a slider positioned in the slot and running along a track positioned within the slot and wherein the blade is affixed to the slider.

6. The hand tool according to claim 5 wherein the slider and attached blade are held in position at a plurality of positions along the track.

7. The hand tool according to claim 6 wherein the slot includes a plurality of serrated edges to facility holding the slider and blade in a specified position.

8. The hand tool according to claim 5 wherein the slider includes a button affixed to a top surface of the slider, the button being depressed to enable the slider to slide on the track.

9. The hand tool according to claim 1 wherein the main case includes a plurality of ridges located on a surface of the main case.

10. The hand tool according to claim 1 wherein the retractable blade is a rotatable blade extending from an edge of the main case when in an extended position.

11. The hand tool according to claim 10 wherein the rotatable blade is a letter opener blade.

12. The hand tool according to claim 1 wherein the blade is configured as a letter opener blade.

13. The hand tool according to claim 1 further comprising a second blade having a letter opening blade, the extendable blade and the second blade sliding in a common slot on the main case.

14. The hand tool according to claim 1 further comprising a second blade having a letter opening blade, the second blade being rotatable and extending beyond an edge of the main case when in the extended position.

15. The hand tool according to claim 1 further comprising a writing utensil tool, the writing utensil tool being retractable from the flat edge of the main case.

16. The hand tool according to claim 1 further comprising a needle tool, the needle tool being retractable from the flat edge of the main case.

17. The hand tool according to claim 1 further comprising a safety cutting tool located on the flat edge of the main case, wherein the safety cutting tool includes a cutting blade and a skid configured to guide material to the cutting blade.

18. The hand tool according to claim 1 further comprising an extended squeegee extending from the main case.

19. The hand tool according to claim 1 further comprising a water injecting system configured to inject water out through a plurality of openings located on the squeegee.

20. The hand tool according to claim 1 wherein the blade includes a cutting edge and is segmented and configured to remove a first segment to reveal a second cutting edge.

21. The hand tool according to claim 1 wherein the main case includes a safety cutter located on an edge of the main case.

22. The hand tool according to claim 21 wherein the safety cutter includes a cutting blade and a skid.

23. The hand tool according to claim 16 further comprising a retractable pen extending from an edge of the main case.

24. The hand tool according to claim 1 wherein the retractable blade is spring-loaded to an extended position.

25. The hand tool according to claim 1 wherein the retractable blade is spring-loaded to a retracted position.

26. The hand tool according to claim 20 further comprising:
a writing utensil tool, the writing utensil tool being retractable from the flat edge of the main case; and
a needle tool, the needle tool being retractable from the flat edge of the main case.

27. The hand tool according to claim 20 wherein the main case includes a safety cutter located on an edge of the main case.

28. The hand tool according to claim 20 further comprising an extended squeegee extending from the main case.

29. The hand tool according to claim 1 further comprising:
a writing utensil tool, the writing utensil tool being retractable from the flat edge of the main case;
a needle tool, the needle tool being retractable from the flat edge of the main case; and
an extended squeegee extending from the main case.
